(19) United States
(12) Patent Application Publication
(10) Pub. No.: US 2008/0005673 A1
(43) Pub. Date: Jan. 3, 2008

(54) Rapid file selection interface

(76) Inventor: Jason C. Thane, Seattle, WA (US)

Correspondence Address: GRAYBEAL, JACKSON, HALEY LLP, 155 - 108TH AVENUE NE, SUITE 350, BELLEVUE, WA, 98004-5973, US

(21) Appl. No.: 11/811,390

(22) Filed: Jun. 8, 2007

Related U.S. Application Data
(63) Continuation of application No. PCT/US05/44387, filed on Dec. 8, 2005.
(60) Provisional application No. 60/634,632, filed on Dec. 8, 2004.

(51) Int. Cl. G06F 3/00

(52) U.S. Cl. 715/700

(57) ABSTRACT

A digital media playback method, apparatus and system for the selection of digital media files from a library of available content using metada.

### FIELD OF INVENTION

This invention relates generally to digital media playback methods, apparatus and systems, and, more specifically, to the selection of digital media files from a library of available content.

### BACKGROUND OF THE INVENTION

Recent advances in digital media storage devices and the sophistication of media compression formats have led to widespread use of large media content libraries in portable or mobile form. More and more, consumers are accessing hundreds or even thousands of music and video files on small devices and portable players. Due to size constraints, these devices tend to have limited display areas and limited user input means such as keys or buttons. This has created a problem of accessibility when a user attempts to single out a specific file for playback.

Portable media playback devices have addressed this problem by displaying a hierarchical organization of metadata, i.e. the descriptive names and titles contained within digital media files. The Apple iPod and similar devices display lists of this metadata and allow the user to scroll up and down these lists in search of a desired item. However, it becomes tedious and time consuming for the user to visually search the list for the desired name or title as it scrolls. Lacking a direct means of selection, the user experiences increasing difficulty as the size of the library grows.

Another problem with interfaces that display lists of metadata for selection is evident in that the user generally expects the lists to be presented in alphabetical order. Digital media interfaces typically satisfy this expectation by sorting lists alphabetically. However, this type of sorting precludes sorting by other fields such as relevance, popularity, or user preference, all of which improve the speed and ease with which the user can access desired content. This advanced sorting is very important when used with large content libraries, because it increases the probability that desired content will be displayed.

Wireless technology will soon enable the use of global media libraries containing millions of media files tracks or more for portable or mobile devices. With this large supply of content, list-based selection interfaces will become extremely difficult to navigate because the lists will be too long for the user to scroll through or comfortably parse.

### SUMMARY OF THE INVENTION

The invention is directed to methods, and apparatus and systems that employ such methods, for searching for or selecting from specific data files comprising metadata using ambiguous input sequence matching. As used herein, the term “ambiguous input” means the generation of at least one unique input signal through a single user operation that represents a plurality of values where the plurality of values comprise an intended value. This ambiguous input is resolved through evaluation of additional input signals, each representing the same plurality of values or additional pluralities of values. One presently available embodiment employing ambiguous input and resolution is the T9 predictive text input scheme. Here, each of a plurality of input means such as telephone keys have multiple values such as letters or numeric symbols; the value of each such key is ambiguous since each key can represent any one of the multiple values associated with that key. However, when provided with a set of rules identifying permissible combinations of values, such as grammar rules, and as more key strokes are logged, the domain of permissible value combinations decreases until the least number of valid value combinations are reached. Moreover, at any point during the entry and logging process, a list of permissible value combinations based only on the received input signals may be presented, and/or a list of all possible permissible value combinations may be presented (this aspect is referred to herein as “predictive value generation” since the operation has not received all input signals but presents a list of available permissible value combinations beyond the possible permissible value combinations based only upon received input signals).

With respect to the invention, the permissible value combinations comprise metadata derived from information associated with data files that comprise an accessible library of such files. In embodiments of the invention pertaining to data files encoding music, for example, the metadata may comprise at least one of the artist name, album name, track title, genre, etc. The selection of suitable metadata information is flexible and is preferably consistent for an entire library comprising media files to be searched and read by a playback device. Moreover, the metadata in its entirety is not generally discernable by the end user; only portions thereof relevant to the user's search query are generally displayed. While this preferred approach is not exclusive, given the relatively limited display area available on portable devices it is considered preferable in many instances.

Once suitable metadata has been established with respect to the library files to be searched, the rules for predictive value generation can be created: permissible value combinations comprise at least part of the metadata for each file for which metadata has been established. Thus, the information-rich metadata can then be parsed according to search criteria created by a user through ambiguous input that is transformed into permissible value combinations, which correspond to intended . In certain embodiments of the invention, each received input signal, which corresponds to a plurality of possible values, reduces the number of files associated with metadata matching the permissible value combinations associated with the received signal combination.

A feature of select embodiments of the invention pertains to a cached data structure of metadata for rapid association with a given input signal sequence. This allows a result set for certain input signal sequences to be determined in advance of the user input, so that the computation time required for determining the matches contained within a large set does not delay the response.

Another feature of select embodiments of the invention provides for returning portions of matching metadata lists in lieu of a full list of matches. Accordingly, if the library data structure and a user display are connected via a limited-bandwidth data conduit, search results can be obtained quickly.

Yet another feature of select embodiments of the invention provides a matching algorithm that allows for multiple instances of ignored or unincluded values to follow an instance of a matched value. Thus, users are able to ignore or omit values in the metadata that are not intuitively available to the user via the input means: the character “a” may not be available to the user for input via a traditional telecommunications keypad. Moreover, if this approach is employed, a user may be comfortably limited to only English alphanumeric characters and may ignore conventional non-alpha characters such as spaces and punctuation.

Still another feature of embodiments of the invention provides a matching algorithm that requires the beginning of any permissible value combination to be at a boundary established within the metadata. The metadata is created with established boundaries, which may coincide with user intuitive boundaries such as between titles, authors, tracks, etc. Because of this provision, only select metadata having matching permissible value combinations at the beginning of a boundary will be passed to the user or subsequent search subset. For example, only those files having metadata permissible value combinations at the beginning of each boundary matching the value combinations entered by the user will be selected; metadata containing only matches beginning in the middle of a permissible value combination would not selected, thereby refining the results and enhancing usability.

According to another aspect of embodiments of the invention, methods are provided for selectively applying portions of the metadata during the matching process. In these embodiments, the permissible value combinations are limited to a subset of the metadata; if no match is found using a first subset of the metadata (either by the match returning a null value or through user intervention), then a second subset is used, and so on until a desired match is found or the search terminated. For example, the first subset may be artists' names and the second subset may be track titles while the third subset may be album titles. This aspect may be user selectable—a configuration file can be used and modified to prioritize the order of subset searching.

Certain embodiments of the invention apply a sort algorithm to some or all returned match sets based upon intrinsic data, e.g., metadata, or extrinsic data, e.g., user preferences. With respect to data files encoding music, the algorithm may include considerations for the match position, content popularity, and last play time of the metadata. The use of such an algorithm is made feasible by the direct nature of the selection procedure provided in the interface, and gives the user a higher probability of finding the desired metadata quickly.

Other embodiments of the invention permit the user to open or execute multiple data files within a match set: if the permissible value combination yields multiple data files, this feature will allow a user to open or execute all data files for which the permissible value combination is true. Thus, a user seeking data files encoding music corresponding to a particular album will be presented with all tracks of that album, and may elect, with a single action, to play all of them.

Apparatus embodying the methods of the invention comprise stand-alone audio-visual devices capable of decoding and transforming data files encoding audio, visual and audio-visual presentations as well as executing machine readable instructions to carryout the described methods, whether such instructions are based in software or firmware. Such devices comprise a visual display, a plurality of input means such as buttons or keys, to which are assigned a plurality of values for each input means where the input means generate a unique signal in response to user operation. Exemplary devices presently include display enabled MP3 players, personal information managers, and display enabled mobile telephones. As implied therein, such devices may be in bi-directionally data communication with another device, computer or network, or may be stand alone, depending upon the mode of implementation.

In addition, apparatus embodying the methods of the invention comprise desktop and mobile computers capable of decoding and transforming data files encoding audio, visual and audio-visual presentations as well as executing machine readable instructions to carryout the described methods, whether such instructions are based in software or firmware. To emulate the mobile environment, the referenced computers include software instructions for displaying a user interface (“UI”) that emulates the mobile experience, and user input is accomplished preferably in a graphical manner.

These and other features of the invention will be described in greater detail by referring to the accompanying figures and related description.

### BRIEF DESCRIPTION OF THE FIGURES

FIG. 1 depicts the layout of a user interface for a preferred embodiment;

FIG. 2 illustrates a software object model utilized in a preferred embodiment;

FIG. 3 illustrates a cached library list data structure;

FIG. 4 is a listing of regular expression fragments used to build a matcher in a preferred embodiment;

FIG. 5 is a detail of a regular expression as it is applied to metadata;

FIG. 6 is a flowchart depicting a metadata selection procedure;

FIG. 7 is a flowchart depicting a procedure used to retrieve a list of matches from a cached library data structure;

FIG. 8 is a flowchart depicting a procedure used to narrow a list of matches that is shorter than the cache threshold;

FIG. 9 is a flowchart depicting a procedure used to apply a given key sequence to multiple metadata categories;

FIG. 10 is a flowchart depicting a layered sort algorithm;

FIG. 11 depicts a layout of a metadata list after it has been processed by a layered sort algorithm;

FIG. 12 is a flowchart depicting a procedure for playback of media files corresponding to selected metadata; and

FIG. 13 depicts an embodiment of the invention implemented as a client-server system.

### DETAILED DESCRIPTION OF EMBODIMENTS OF THE INVENTION

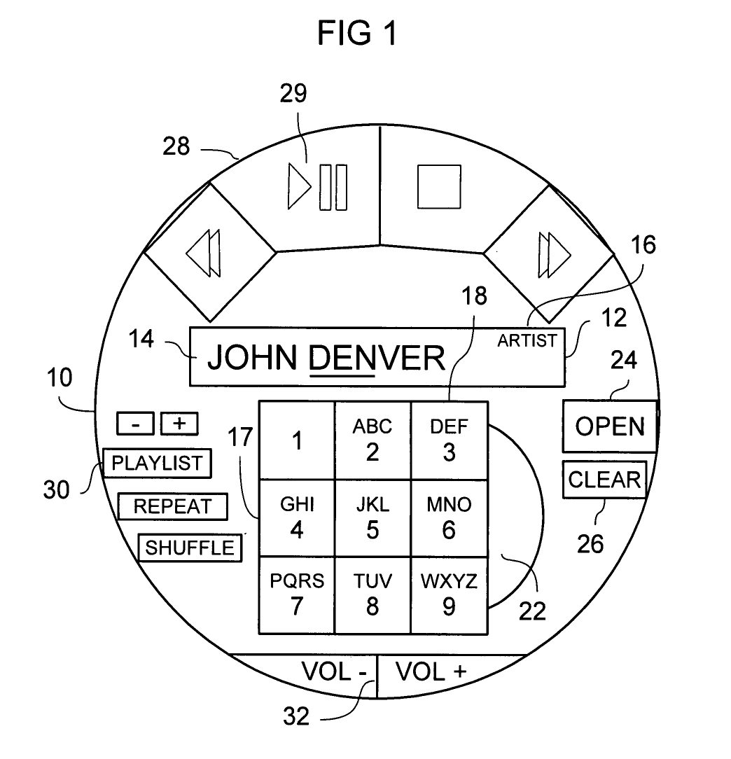

A preferred embodiment of the user interface is illustrated in FIG. 1 and described in the context of a media player software application. In this embodiment, the software executes within the Windows operating system available from Microsoft Corp of Redmond, Wash. Display of the user interface and its operation are achieved via the graphics and user input facilities provided by the operating system. The user interface may alternatively be implemented to execute within a different operating system, or as a portable hardware device having physical pushbuttons and a display screen.

As detailed in FIG. 1, the player 10 includes a metadata display area 12. The display area includes a rendering of the currently selected metadata 14 and a metadata category indicator 16.

On a typical computer monitor screen, the player 10 measures about 3″ in diameter. The display area 12 is about 1.75″ wide by about 0.5″ tall. This interface is intended to emulate a generic portable device input/output interface where a user has limited signal input means, such as keys 18.

The player 10 includes an array 17 of selection keys 18, each bearing a label showing a set of values or characters. Additionally included is a jog dial 22 which may be rotated either upward or downward, an open button 24, a clear button 26, a set of playback control buttons 28 including a play button 29, a set of playlist control buttons 30, and a set of volume control buttons 32.

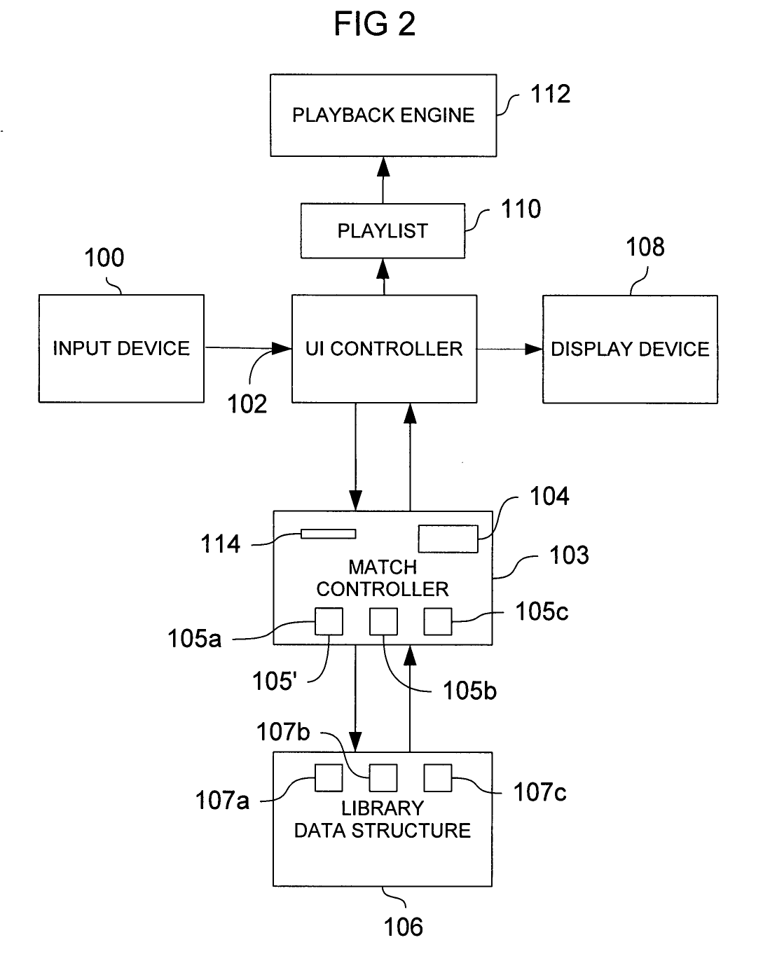

FIG. 2 is a schematic diagram of the software object model underlying the user interface. The input device object 100 is interfaced to a UI controller 102, which in turn interfaces with a match controller object 103, a display device object 108, and a playlist object 110. The match controller is interfaced to a library data structure 106, and the playlist object 110 is interfaced to a playback engine object 112.

The match controller contains three match list objects; an artist list object 105a, an album list object 105b, and a track list object 105c. In this case, the term track could refer to any content, e.g. a music track or video track. One match list object is indicated as the currently selected match list 105′. The match controller additionally holds a current regular expression 114, and a reference to a regular expression engine 104.

Similarly, the library data structure 106 contains three library list objects; an artist list object 107a, an album list object 107b, and a track list object 107c.

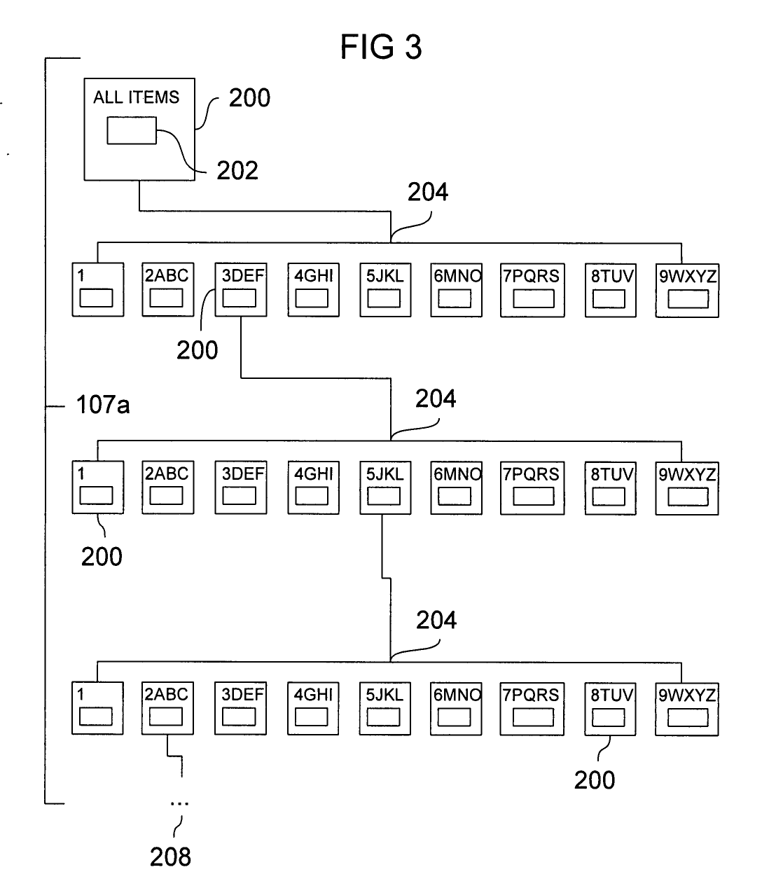

FIG. 3 is a detailed view of a single library list data structure 107a. This object is a hierarchical organization of metadata serving as a library cache. Each list object 200 is an instance of the library list class, and each contains a metadata list 202.

If the metadata list 202 is greater in length than a given threshold, a list object 200 additionally contains an array 204 of child list objects 200. Each child list object corresponds to a single match selection key 18. Each child list object encapsulates a subset of the parent's metadata references as its metadata list 202. If the metadata list 202 is shorter in length than the given threshold, a list object 200 has no array of child list objects and is considered a leaf node. Ellipses 208 are used to indicate the presence of additional child list arrays 204 not shown on the diagram.

The preferred embodiment uses a regular expression created by the user's key sequence to test whether or not each metadata item is a match. A regular expression is a string that describes or matches a set of strings according to certain syntax rules. A regular expression engine determines whether or not a given string matches a regular expression based on these syntax rules. In the preferred embodiment, the regular expression engine used is the JRegex library, available via the Internet at http://jregex.sourceforge.net.

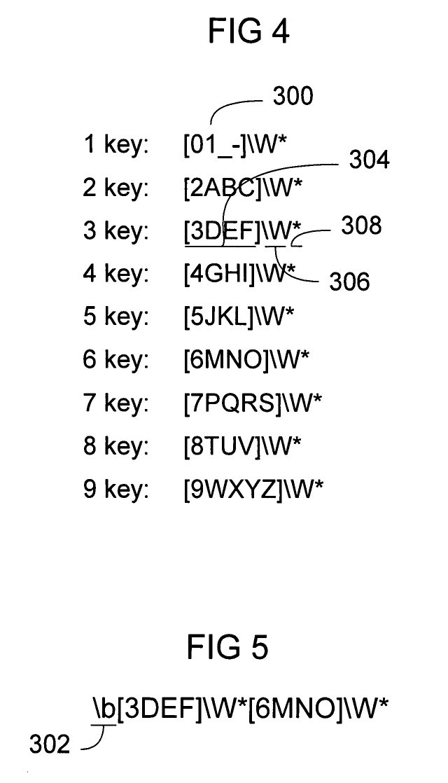

An exemplary set of regular expression fragments in the preferred embodiment are shown in FIG. 4. Each regular expression fragment 300 corresponds to a selection key 18. In alternative embodiments, these regular expression fragments may vary to include analogous non-English characters or other characters not shown on the selection keys.

Each fragment 300 contains three parts: a character class assertion 304 ([3DEF]), a non alphanumeric character assertion 306 (\W), and an indefinite quantifier 308 (*). The assertion 304 is a set of characters enclosed in square brackets that, in the regular expression implementation used, requires exactly one of the characters to be present for a match to be successful. The assertion 306 matches any instance of a non alphanumeric character. It is modified by the indefinite quantifier 308, which modifies the assertion 306 to allow 0 or more instances of a non alphanumeric character at this position in the match.

Via this mechanism, a user is allowed to input a key sequence that omits or ignores the presence of non alphanumeric characters, such as spaces and punctuation. After each character required by a key 18, any number of non alphanumeric characters are allowed by the match test.

An exemplary regular expression string is detailed in FIG. 5. The regular expression string begins with a word boundary assertion 302 (\b), and then regular expression fragments 300 are appended as the user enters keys 18. In the regular expression implementation used, a word boundary assertion matches any position between an instance of an alphanumeric character and an instance of a non alphanumeric character as well as the beginning and end of the metadata.

The word boundary assertion ensures that matches will only begin at the beginning of a word or name within the metadata. This allows the user to search by last name, i.e. “DEN” for “John Denver”, without receiving matches that begin in the middle of a name, i.e. “DEN” in “String Cheese Incident”.

In alternative embodiments, the determination of a match or non match for a given key sequence can be made using a procedure which does not include a regular expression or a regular expression engine. In these embodiments, equivalent logic is implemented in string processing functions to determine whether or not a metadata item matches the given key sequence.

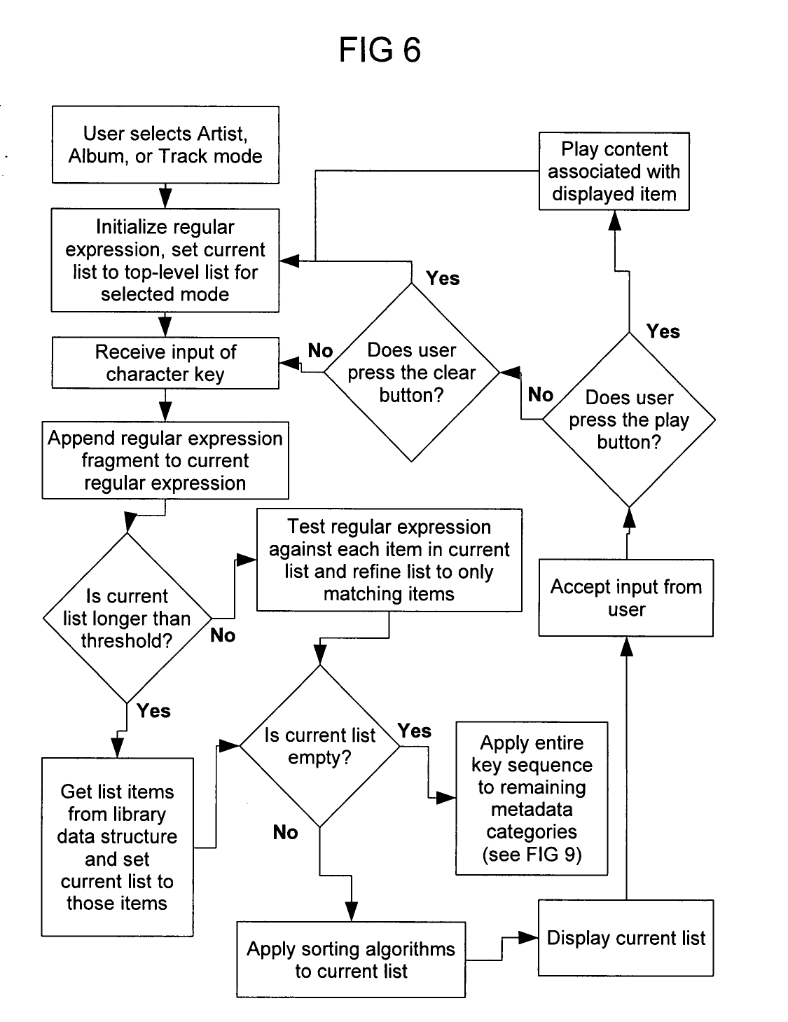

FIG. 6 is a flowchart depicting the metadata selection procedure in the preferred embodiment. The user's input of a selection key 18 appends the corresponding regular expression fragment 300 to the current regular expression 114. If the currently selected match list 105′ is longer than a threshold of 100 items, a resultant list is retrieved from the library data structure 106. Otherwise, the list is refined by testing the current regular expression against each item. In alternative embodiments, the threshold may be higher or lower than 100 in order to suit the memory and processing capabilities of the device implementing the interface.

After the list refinement is complete, if the list has no remaining items, the entire key sequence used to refine the list is applied to any remaining metadata categories.

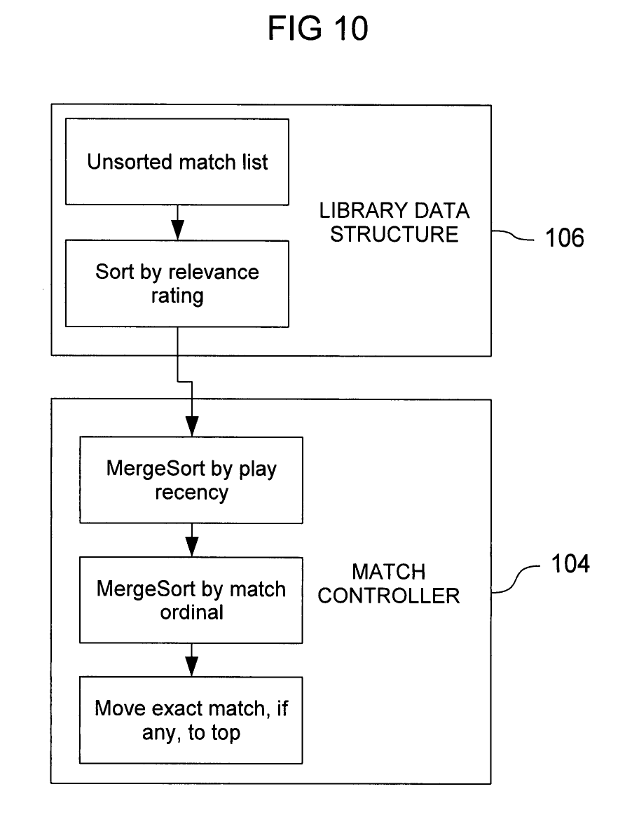

If the list has remaining items, the layered sort algorithm described in FIG. 10 is applied to the list, and it is displayed via the display device object 108. When the list is displayed, the user may move the jog dial 22 upward or downward to view the full contents of the list.

The user then has the option of playing the content associated with the selected metadata, pressing the clear button 26 to restart the match process, or pressing another selection key 18 to further refine the match.

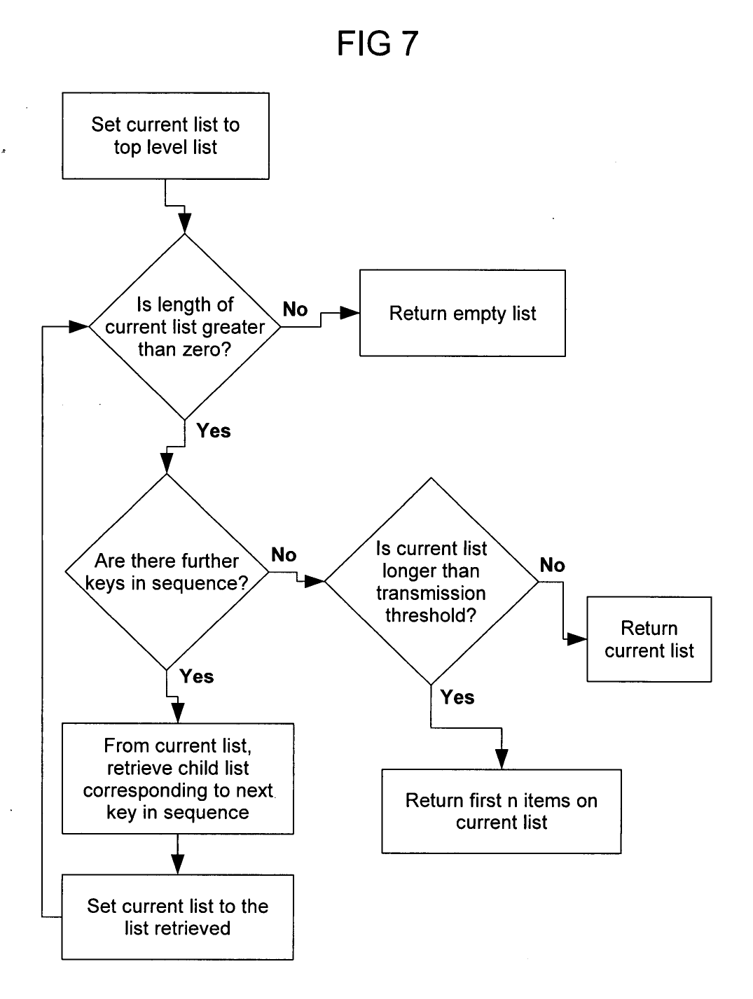

FIG. 7 shows the process by which a match list is retrieved from the library data structure. For each key in the sequence that has been entered by the user, a child list 200 is selected and set as the current list. When all keys in the input sequence have been applied to the selection of child lists, the current list is returned. If a leaf node is encountered, it is returned for further refinement by the match controller 103.

If a match list produced by the library data structure 106 is greater in length than a given threshold, in the preferred embodiment 100, it is truncated before it is returned to the match controller 103. Alternative embodiments of the invention may include a network connection between the library data structure and the match controller. The truncation of the match list produced by the library data structure reduces the time needed to transmit the list of matches across the network connection, thereby speeding the response to the user. In various embodiments, the truncation threshold may be higher or lower than 100 in order to suit the speed of the network connection used.

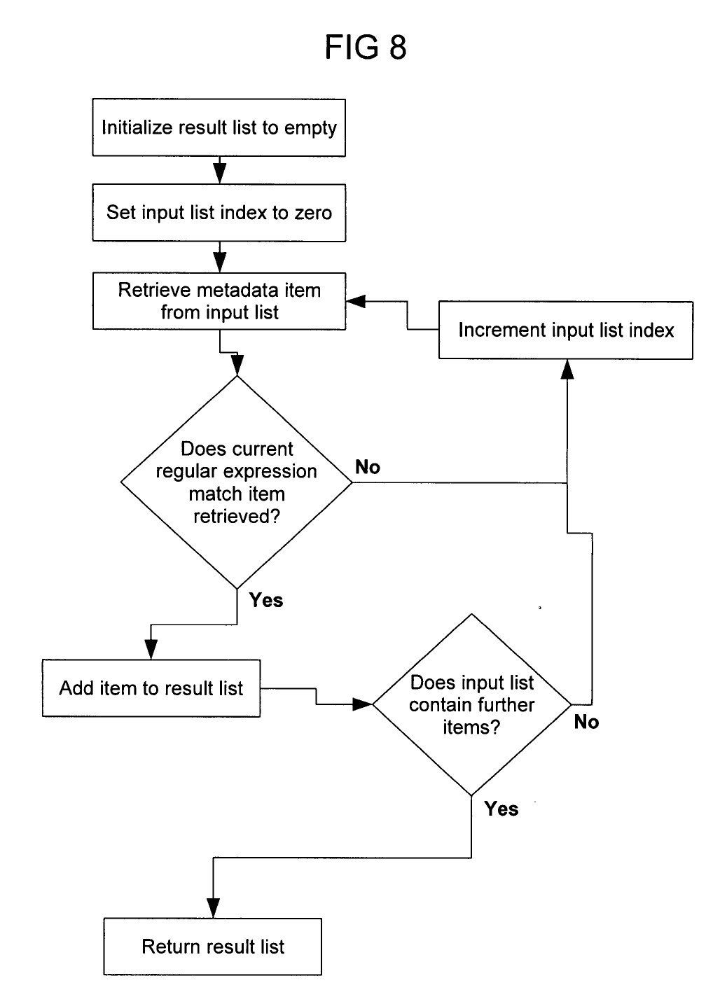

FIG. 8 shows the process by which the current match list 105′ is refined within the match controller object 103. After a result list is initialized, each item in the current match list is tested with the current regular expression 114 in case insensitive mode and added to the result list if the test is successful. The result list is then returned.

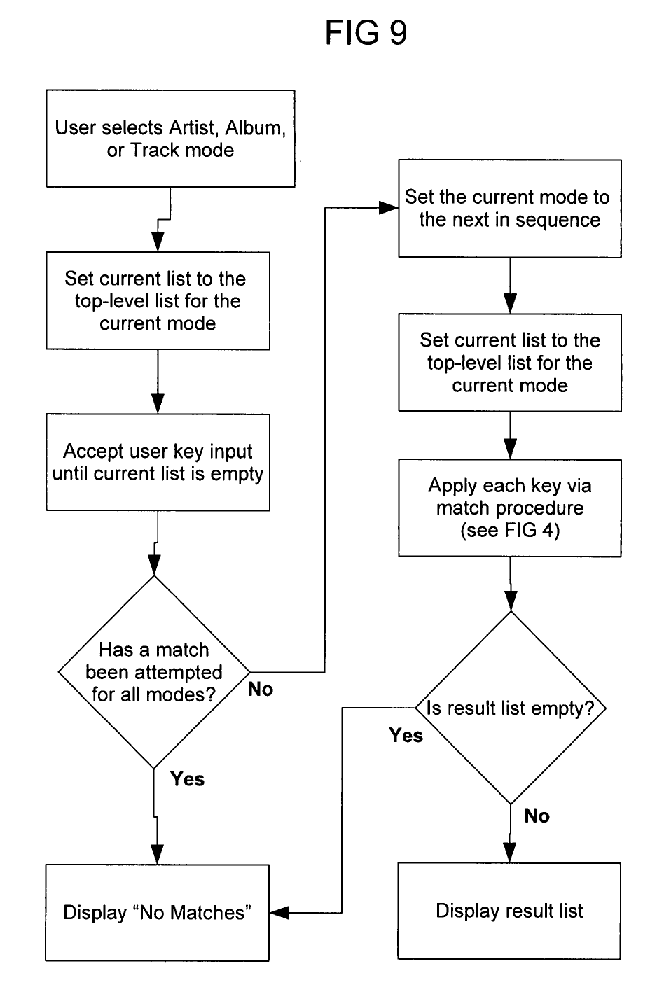

FIG. 9 shows the process followed when an attempted match for the current metadata category produces no results. The entire key sequence entered by the user is applied to each possible metadata category, i.e. artist, album, and track. If a non-empty match list is produced for an alternative metadata category, an item from that list is displayed. If there are no matches for any alternative metadata category, the string “NO MATCHES” is displayed.

FIG. 10 illustrates the layered sort algorithm. Prior to any user input, the child match lists contained within the library data structure 106 are sorted by a relevance rating. In alternative embodiments, this relevance rating may be the result of a popularity ranking based on the Billboard Top 100 or another media popularity index.

When a match list is returned to the match controller object 103, MergeSort or another stable sort algorithm is applied to sort the list items by the time at which the user last played each item. The use of a stable sort algorithm ensures that items that have not yet been played by the user will remain in the relevance or popularity order that was created by the previous sort.

Next, MergeSort or another stable sort algorithm is applied to sort the items by the ordinal position of the current match within the metadata. Items that were matched at the first character in the metadata precede items that were matched at later characters. The use of a stable sort algorithm ensures that for items with equivalent match position ordinals, the order created by the previous two sorts will persist.

Last, if an exact match exists, it is moved to the first position in the list. An exact match is defined as a metadata item having the same number of alphanumeric characters as the number of selection keys that have been entered by the user. This provision exists so that the user is able to directly select an exactly matching without the use of the jog dial 22.

This layered sort algorithm causes metadata to be presented in the following order of preference: 1) items which are closely or exactly specified by the key sequence, 2) items which the user prefers, and 3) items which are generally popular.

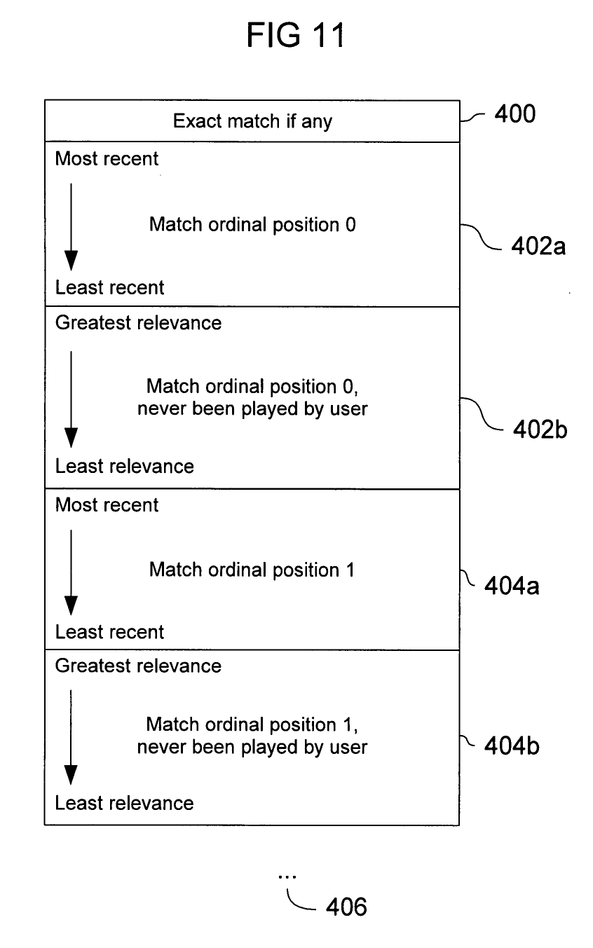

FIG. 11 is a detailed view of a metadata list object 105a which has been arranged by the sort algorithm.

The exact match 400 appears at the top of the metadata list, followed by sections of the metadata list 402a, 402b, 404a, and 404b. Section 402a contains metadata objects having a match position ordinal of 0 and an associated play recency value, ordered descending from most to least recent. Section 402b contains metadata objects having a match position ordinal of 0 and no associated play recency value, ordered descending from greatest relevance to least relevance. Similarly, sections 404a and 404b follow with metadata objects having a match position ordinal of 1. Ellipses 406 are used to indicate that an indeterminate further number of sections follow with the same structure as those shown.

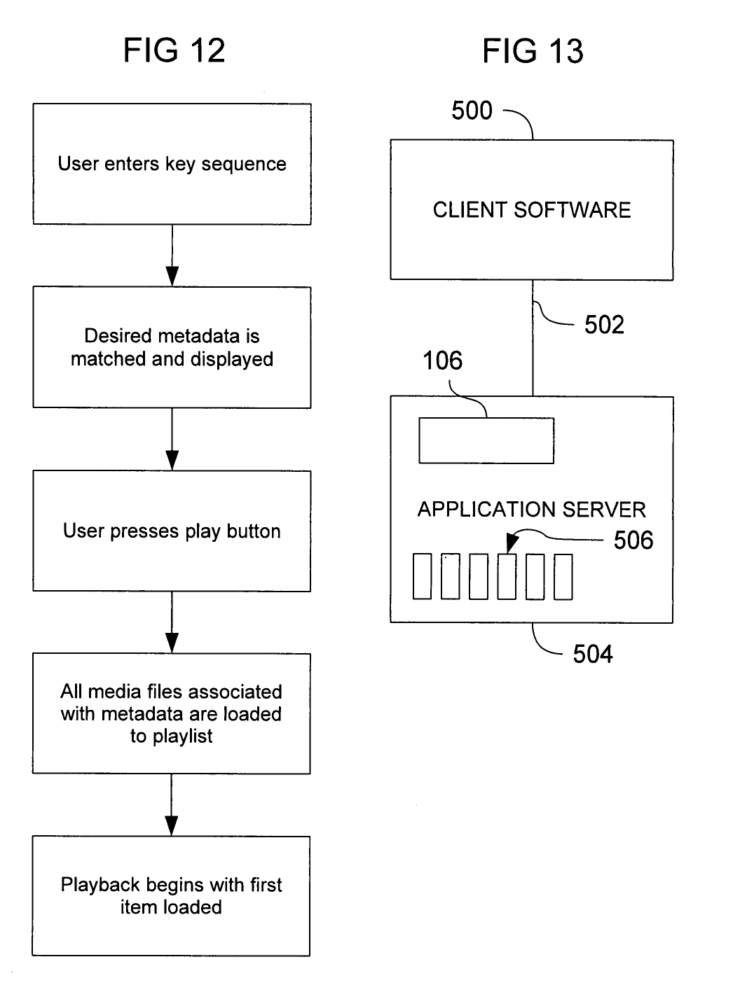

FIG. 12 is an overview of how media files are selected and enqueued for playback. The user enters a key sequence for a desired metadata item, which is displayed. The user then presses the play button 29, and all media files associated with the selected metadata are enqueued on the playlist. Playback begins with the first item enqueued within the playlist object 110.

### Alternative Embodiments

There are various possibilities with regard to the context in which the invention is applied. FIG. 13 shows aspects of the invention implemented as a client-server system across a network connection. The client or device 500 implements the user input and display functionality, the match controller, and the playback engine, and the remote application server 504 implements the library data structure 106 and returns metadata lists across the network connection 502. When a metadata selection is made, the corresponding media files 506 resident on the application server are streamed or downloaded to the client for playback. This embodiment allows selections to be made from a very large library of digital content provided by the application server and then transferred to the user's client or device as needed for playback.

Another possible embodiment of the invention may be implemented as software executing on a mobile phone connected wirelessly to the digital content library and application server. The numeric keys provided by the mobile phone are used as the selection keys, and the phone's display is used as the display device. The additional buttons provided by the mobile phone are used to activate and control playback. The library data structure is implemented by a remote application server 504 which returns metadata lists across the wireless data connection. When a metadata selection is made, the corresponding media files 506 are streamed or downloaded to the mobile phone for playback through headphones or another connected speaker.

The invention can also be embodied as an automotive dashboard component, a countertop or desktop home appliance, or an in-wall keypad and display controlling music playback in the home. In all of these cases, the device may be connected to either a local or a remote content library.

Additional alternative embodiments are possible where the number of selection keys available as well as the sets of characters associated with each key varies. Each key may have more or less associated alphanumeric characters, and the user interface may have more or less selection keys provided in the array. In these embodiments, the format of the library data structure and the syntax of the regular expressions used may be modified.

Alternative embodiments are also possible where the key sequence matching logic is extended to utilize non US character sets. In these embodiments, the keys used to specify a match may correspond to additional or alternative characters. Additionally, the set of unincluded characters, described in the preferred embodiment as the set of non alphanumeric characters, may be defined differently to suit the user's local or the number of keys available on the input device. In these embodiments, the format of the library data structure and the syntax of the regular expressions used may be modified.

Accordingly, the embodiments described herein provide a user interface that enables quick, direct, and articulate selection and playback of digital media from an available content library. One or more of these embodiments overcome significant usability challenges presented by the advent of digital media libraries used with mobile or portable devices. Additional advantages include
rapid selection from a digital media library using a limited-size user interface
ambiguous key sequence matching experience that is optimized for the selection of digital media metadata
use of increasingly large content libraries while minimizing the presentation of undesired content
the efficient use of remote digital media library connected by a network such as the Internet
relevance or popularity sorting logic to be applied to metadata searched, where such sorting might otherwise be confusing

Although the description above contains many specificities, these should not be construed as limiting the scope of the invention but as merely providing illustrations of some of the presently preferred embodiments of the invention.

Thus the scope of the invention should be determined by the appended claims and their legal equivalents, rather than by the examples given.

What is claimed:

1. A method for selecting at least one machine readable file from a plurality of machine readable files wherein at least some machine readable files comprise metadata, the metadata including permissible value combinations, relating to each such file, the method comprising:
a) selecting a first plurality of values through a single operation;
b) comparing the first plurality of values to the metadata;
c) identifying a first set of metadata comprising at least one value from the first plurality of values;
d) selecting a subsequent plurality of values through a single operation;
e) comparing the subsequent plurality of values to the first or prior set of metadata; and
f) identifying a subsequent set of metadata comprising at least one value from the first plurality of values followed sequentially by at least one value from each subsequent plurality of values to form a new combination of values, wherein the new combination of values comprises permissible value combinations.

2. The method of claim 1 wherein the second set is a subset of the first set.

3. The method of claim 1 further comprising storing the first set of metadata.

4. The method of claim 3 further comprising storing the second set of metadata.

5. The method of claim 1 wherein the at least one value of the second plurality of values may include a null value not corresponding to any user known value.

6. The method of claim 1 wherein at least some of the metadata comprises a boundary flag and wherein the step of identifying a first set of metadata occurs adjacent to a boundary flag.

7. The method of claim 6 wherein the boundary flag comprises a non-alphanumeric value.

8. The method of claim 1 wherein the metadata comprises groups of permissible value combinations.

9. The method of claim 8 further comprising repeating the steps of d), e) and f for a first group until a last set of metadata does not comprise a permissible value combination for that group, then repeating the same method for a subsequent group until a last set of metadata only comprises permissible value groups.

10. The method of claim 8 wherein the determination of group hierarchy is selected by a user.

11. The method of claim 10 wherein metadata comprising predefined portions thereof that are not part of any set of data are included with the subsequent set of metadata when the subsequent set of metadata also comprises the predefined portions.

12. The method of claim 1 further comprising ordering any subsequent set of metadata according to a defined hierarchy.

13. The method of claim 12 wherein the hierarchy is user selectable.

14. The method of claim 12 wherein at least a portion of the metadata for each identified file is used to order the set of metadata.

15. The method of claim 12 wherein data derived from file access history is used to order the set of metadata.

16. The method of claim 12 wherein a combination of at least a portion of the metadata for each identified file is used to order the set of metadata.

17. The method of claim 12 wherein the ordinal position of the last new combination of values within the last set of metadata is used to order the set of metadata.

18. The method of claim 12 wherein metadata having total values equal in number to the number of total single operations will be used to order the set of metadata.
